(19) United States
(12) Patent Application Publication
(10) Pub. No.: US 2007/0164077 A1
(43) Pub. Date: Jul. 19, 2007

(54) Weld nut part detector for welding applications

(76) Inventors: Rosendo Pulido, New Albany, MS (US); Ronnie Powell, Mantachie, MS (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/359,933

(22) Filed: Feb. 22, 2006

Related U.S. Application Data
(60) Provisional application No. 60/655,096, filed on Feb. 22, 2005.

(51) Int. Cl. B23Q 15/00

(52) U.S. Cl. 228/10

(57) ABSTRACT

A sensor assembly includes a pin housing and a fiber optic sensor. The pin housing receives an end of the fiber optic sensor. The fiber optic sensor has a side-view probe type sensing end which permits right angle sensing. The pin housing includes a side hole that corresponds to a side opening of the sensor allowing light to pass therethrough.

### CROSS REFERENCE TO RELATED APPLICATION

This application claims priority to U.S. provisional patent application No. 60/655,096, which was filed on Feb. 22, 2005 and is incorporated herein by reference in its entirety.

### BACKGROUND OF THE INVENTION

1. Field of the Invention

The invention relates to a device for detecting the presence of a part to be welded prior to commencing welding of the part. More specifically, the invention relates to a housing that protects a fiber optic cable during the welding operation.

2. Description of the Related Art

In robotic welding applications it is desirable to provide a sensor for detecting the presence or absence of a part which is to be welded, such as a weld nut, prior to starting the welding operation. Such a sensor must be able to provide good performance in the welding environment. Further, the sensor must be able to withstand the intense heat and sparks produced during operation of the welding equipment.

Accordingly, it remains desirable to provide a part sensor which is impervious to the heat and sparks found in the welding environment so as to provide reliable and accurate detection of parts during operation of the welding equipment.

### SUMMARY OF THE INVENTION

According to one aspect of the invention, a welding assembly includes a welding device, a control unit and a sensor assembly. The welding device is used for welding together a first part and a second part. The control unit allows operation of the welding device in response to the control unit receiving a reflected light signal indicating the presence of at least one of the first and second parts, the control unit providing an initial light signal. The sensor assembly includes a fiber optic cable and a cylindrically shaped housing. The fiber optic cable carries both the reflected and initial light signals to and from the control unit. The fiber optic cable has a side opening. The housing shields at least a portion of the fiber optic cable during operation of the welding device. The housing has a bore formed at one end for receiving the fiber optic sensor therethrough. The housing has a side hole substantially aligned with the side opening of the fiber optic cable. The side hole allows emission of the initial light signal onto the at least one of the first and second parts. The side hole further allows the reflected light signal to pass therethrough.

According to another aspect of the invention, a pin housing is provided for a fiber optic sensor having a side opening formed in a side thereof. The pin housing includes a cylindrical+body having a bore formed at one end for receiving the fiber optic sensor therethrough and a tip defined at an opposite end. A side hole extends between an outer surface of the body and the bore. The side hole is substantially aligned with the side opening of the fiber optic sensor when the fiber optic sensor is inserted through the bore of the body.

The invention also provides a method of welding together a first part and a second part. The method includes the steps of: positioning the first part onto a locating pin of a welding fixture; positioning the second part onto the locating pin; emitting a light signal through a side opening of the locating pin and onto the second part; sensing a reflected light signal from the second part through the side opening of the locating pin; and welding the first and second parts together with a welding device automatically in response to sensing the reflected light signal.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a cross sectional view of a sensor assembly as part of a welding fixture according to one embodiment of the invention;

FIG. 2 is an exploded perspective view of the sensor assembly shown with first and second parts to be welded together by the welding device;

FIG. 3 is a front elevational view of a pin housing of the sensor assembly;

FIG. 4 is a cross sectional view of the pin housing;

FIG. 5 is a perspective view of the pin housing according to a second embodiment of the invention;

FIG. 6 is a perspective view of the pin housing according to a third embodiment of the invention; and

FIG. 7 is a top elevational view of a sensor used as part of the sensor assembly.

### DETAILED DESCRIPTION OF THE INVENTION

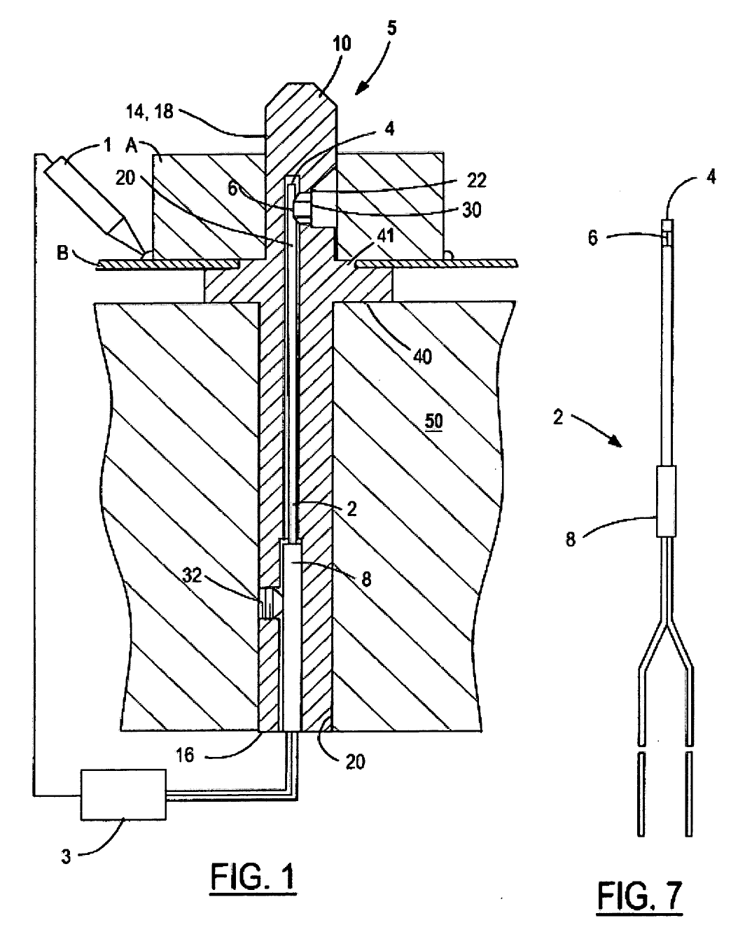

Referring to FIG. 1, the invention relates to a welding fixture having a welding device 1, a control unit 3 and a sensor assembly 5. The sensor assembly 5 detects the presence or absence of parts to be welded, such as a weld nut A and a plate B, by emitting an initial light signal onto at least one of the parts. The light signal is reflected from the part and received by the sensor assembly 5. The reflected light signal is transmitted back to the control unit 3 via the sensor assembly 5. The control unit 3 allows operation of the welding device 1 only when the reflected light signal is received from the sensor assembly 5. The sensor assembly 5 includes a pin housing and a fiber optic sensor. The fiber optic sensor 2, shown in FIG. 7, has a side-view probe type sensing end 4 having a side opening 6 which permits right angle sensing. Described in greater detail below, the pin housing receives the end 4 of the sensor 2 and protects at least a portion of the optic sensor 2 during operation of the welding device 1. The pin housing also includes a side hole that corresponds to the side opening 6 of the sensor 2 to allow the light signals to pass therethrough.

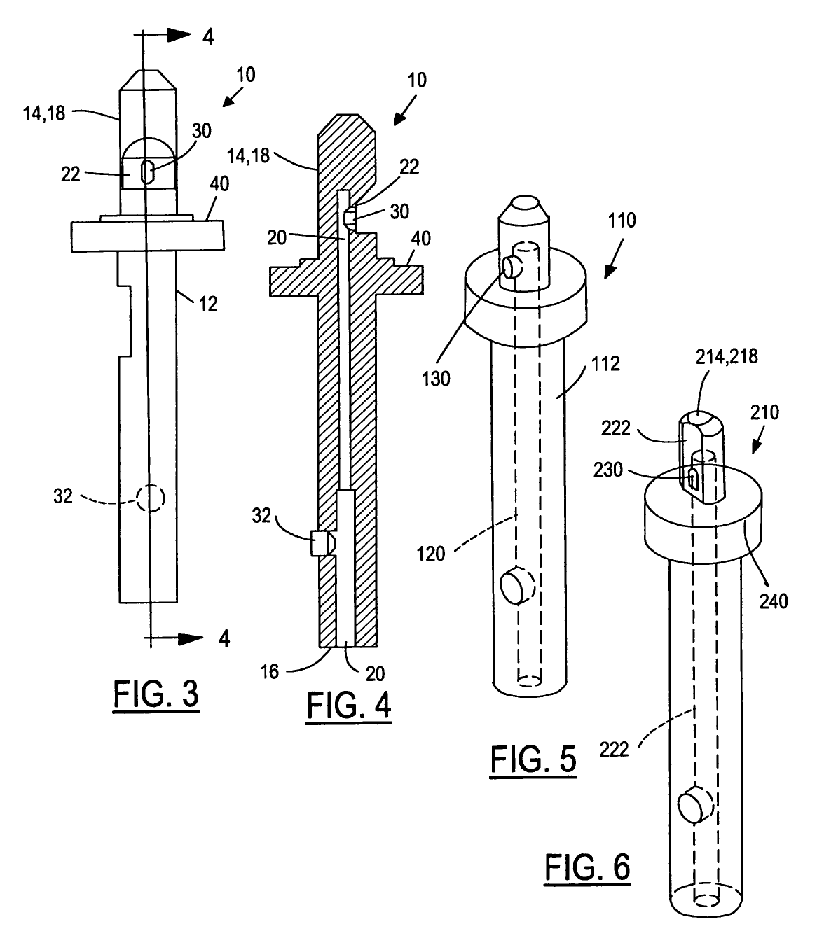

Referring to FIGS. 3 and 4, a pin housing is generally indicated at 10. The pin housing 10 includes a cylindrical body 12 having a tapered tip 18 formed at one end 14 and a bore 20 formed at the opposite end 16. The bore 20 extends axially toward the tip 18 and is adapted to receive the fiber optic sensor 2 therethrough. The body 12 also has a threaded bore 32 to receive a set screw, which engages the sensor to keep the sensor in position within the bore 20 of the housing 10.

A flat surface 22 is formed on the outer surface of the body 12. A side hole 30 extends between the flat surface 22 and the bore 20. The side hole 30 is substantially aligned with the side opening near the tip of the sensing probe. The side hole 30 allows light to pass through the pin housing 10 to the side opening 6 of the optic sensor 2.

An abutment extends outwardly from the body 12 for locating the pin housing 10 in the axial direction when the tip 18 is inserted through the parts to be welded. In one embodiment of the invention, the abutment is provided as an annular shaped first collar 40. A second abutment is provided in the form of a second annular collar 41 that is generally concentric with the first collar 40. The second collar 41 has a smaller diameter than the first collar 40. It should be readily appreciated by those skilled in the art that the abutments can be adapted to have any shape suitable for locating the parts to be welded relative to the fixtures.

One example of a fiber optic sensor which can be used with the invention is the PBPS26U sensor manufactured by Banner Engineering Corporation of Minneapolis, Minn. As shown in FIG. 6, the sensor 2 has a bifurcated plastic fiber optic assembly 8 with a pair of fiber optic cables and a side-view probe type sensing end 4. Sensing light is transmitted through a cable to a side opening 6 located near the tip of the sensing probe 2.

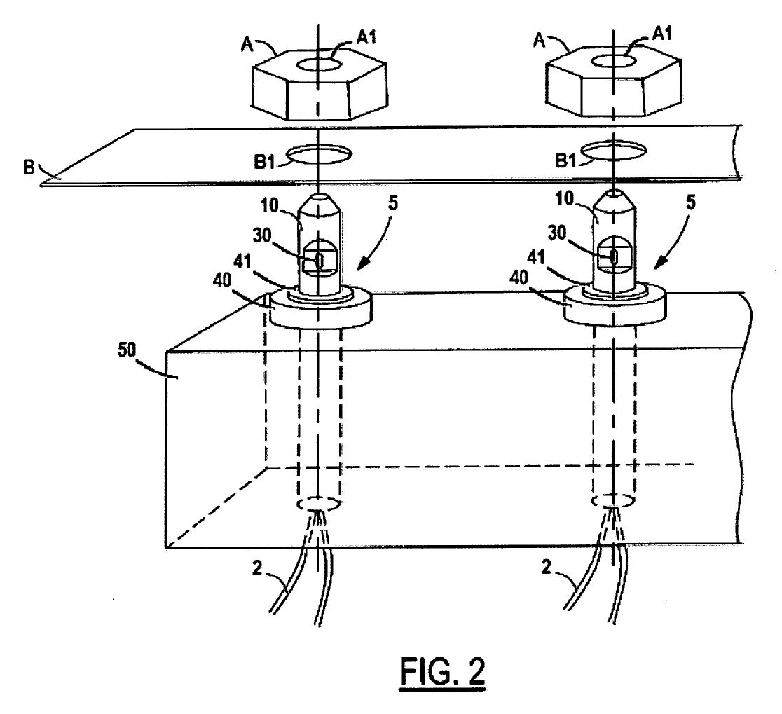

The sensor assembly 5 is formed by inserting the sensing end 4 of the probe inserted through the bore 20 of the housing 10. The side opening 6 is aligned with the side hole 30 of the pin housing 10 to allow light to pass therethrough. The sensor assembly 5 is mounted to a base 50 of the welding fixture. As shown in FIG. 2, multiple sensor assemblies 5 may be used for sensing the presence of multiple parts A to be welded.

Referring to FIGS. 1 and 2, the plate B, as the work piece, is positioned onto the welding fixture, so that the tip 18 and the second collar 41 of each housing 10 extends through respective locating holes B1. The second collar 41 has a diameter that corresponds with the diameter of the locating holes B1 to provide a positive horizontal location of the plate B relative to the weld fixture. The plate B locates in the vertical direction relative to the upper surface of the first collar 40. The nuts A, which are the parts to be welded onto the plate B, are also placed on the fixture, so that the tip 18 of each housing 10 extends through the threaded bores A1 of the respective nuts A. The nuts A locate in the vertical direction relative to the upper surfaces of the second collars 41 and the plate B. The diameter of the tip 18 of the housing 10 corresponds to the diameter of the threaded bores A1 of the nuts A to provide a positive horizontal location of the nuts A relative to the weld fixture. An initial light signal is emitted from the side opening 6 of the probe 2 onto the nuts A. Light reflects from the nuts A back through the side hole 30 of the housing 10 and the side opening 6 of the sensor 2. The reflected light signal is carried by the other fiber optic cable of the sensor 2 to a control unit 3 (FIG. 1). A light-sensitive switch in the control unit 3 is coupled to the sensor and receives the reflected light signal, thereby indicating the presence of the nuts A. In response to receiving the light signal, the control unit 3 enables and allows operation of the welding device 1. If a nut A is not present, a signal is not reflected back to the switch. The control unit 3 is programmed to disable the welding device 1 if a signal is not provided, i.e. if a part to be welded is not present. The welding device 1 remains disabled by the control unit 3 until a reflected light signal is received by the switch in the control unit, indicating that the nut A is properly located onto the tip 18 of the housing 10.

Intense heat and sparks are formed during the welding operation. The pin housing shields the fiber optic sensor from the heat and sparks of the welding operation or other environmental contaminants typically found in a manufacturing setting, such as dirt, moisture and corrosive elements.

Alternatively, a plurality of sensor assemblies, at least three, can be used to detect not only the presence or absence of the part, but also the alignment of the part. If the part is in position, then all three sensors will sense the part is in position. However, if it is out of alignment only a portion of the sensors will provide a reflected light signal back to the control unit, thereby prevent the operation of the welding equipment.

A second embodiment of the housing 110 is shown in FIG. 3. In this embodiment, the body 112 lacks the flat surface 22 of the first embodiment. The side hole 130 extends between an outer cylindrical surface of the body and the bore 120.

A third embodiment of the housing 210 is shown in FIG. 4, wherein the flat surface 222 extends between the collar portion 240 and the tip 218.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

1. A welding assembly comprising:
a welding device for welding together a first part and a second part;
a control unit allowing operation of the welding device in response to the control unit receiving a reflected light signal indicating the presence of at least one of the first and second parts, the control unit providing an initial light signal; and
a sensor assembly comprising:
a fiber optic cable for carrying both the reflected and initial light signals to and from the control unit, the fiber optic cable having a side opening; and
a cylindrically shaped housing shielding at least a portion of the fiber optic cable during operation of the welding device, the housing having a bore formed at one end for receiving the fiber optic sensor therethrough, the housing having a side hole substantially aligned with the side opening of the fiber optic cable, the side hole allowing emission of the initial light signal onto the at least one of the first and second parts, the side hole further allowing the reflected light signal to pass therethrough.

2. The welding assembly as set forth in claim 1, wherein the weld assembly includes a plurality of sensor assemblies for sensing the presence of a plurality of parts.

3. The welding assembly as set forth in claim 1, wherein the side hole extends between the bore and a flat surface formed along an outer surface of the housing.

4. The welding assembly as set forth in claim 3, wherein the bore is generally oval shaped.

5. The welding assembly as set forth in claim 3 including an outwardly extending abutment for axially locating the side hole as the housing is inserted into a hole of a receiving part.

6. The welding assembly as set forth in claim 5 wherein the abutment is an annular collar.

7. The welding assembly as set forth in claim 1 wherein the abutment is an annular collar.

7. The welding assembly as set forth in claim 1 wherein the hole extends orthogonally relative to the bore.

8. A pin housing for a fiber optic sensor having a side opening formed in a side thereof, said pin housing comprising:
a cylindrical body having a bore formed at one end for receiving the fiber optic sensor therethrough and a tip defined at an opposite end;
a side hole extending between an outer surface of the body and the bore, the side hole being substantially aligned with the side opening of the fiber optic sensor when the fiber optic sensor is inserted through the bore of the body.

9. The pin housing as set forth in claim 8 including a threaded bore for receiving a set screw therethrough for retaining the fiber optic sensor within the bore.

10. The pin housing as set forth in claim 8 including a flat surface formed along a portion of the outer surface of the body.

11. The pin housing as set forth in claim 10, wherein the hole extends between the flat surface and the bore.

12. The pin housing as set forth in claim 11, wherein the bore is generally oval shaped.

13. The pin housing as set forth in claim 11 including an abutment extending outwardly from the outer surface of the body for axially locating the tip as the tip is inserted into a hole of a receiving part.

14. The pin housing as set forth in claim 11 including an intermediate collar extending radially outwardly from the body for axially locating the tip as the tip is inserted into a hole of a receiving part.

15. A method of welding together a first part and a second part, said method comprising the steps of:
positioning the first part onto a locating pin of a welding fixture;
positioning the second part onto the locating pin;
emitting a light signal through a side opening of the locating pin and onto the second part;
sensing a reflected light signal from the second part through the side opening of the locating pin; and
welding the first and second parts together with a welding device automatically in response to sensing the reflected light signal.
